(19) United States
(12) Patent Application Publication
(10) Pub. No.: US 2012/0240072 A1
(43) Pub. Date: Sep. 20, 2012

(54) Intensity transform systems and methods

(75) Inventors: Frank Altamura, San Jose, CA (US); Alberto Fonts, Mountain View, CA (US)

(73) Assignee: Serious Materials, Inc., Sunnyvale, CA (US)

(21) Appl. No.: 13/065,297

(22) Filed: Mar. 18, 2011

(51) Int. Cl. G06F 3/048; G06T 11/20

(52) U.S. Cl. 715/771; 345/440

(57) ABSTRACT

A computer-implemented method for collecting, analyzing and displaying energy consumption data associated with a facility includes collecting operational data corresponding to building equipment from the facility. The operational data is fed into a cell among a matrix of cells for intensity transform analysis. The operational data may be ascribed a visual indicator based on one or more predetermined threshold operational data values, thereby generating visual indicators associated with the operational data. The visual indicators may be overlaid on the matrix of cells. The operational data may be correlated with one or more factors internal or external to the facility. The matrix of cells overlaid with the visual indicators may be used to generate a plot showing the energy consumption of the facility as a function of the first dimension and the second dimension

### CROSS-REFERENCE

This application is related to U.S. patent application Ser. No. 12/805,562 (“BUILDING ENERGY MANAGEMENT METHOD AND SYSTEM”), filed on Aug. 5, 2010, which is entirely incorporated herein by reference.

### BACKGROUND OF THE INVENTION

Facilities, such as homes and buildings, consume energy during operation and use. Energy consumption may be used for assessing the efficiency of a facility, building or vehicle.

Buildings may not operate at predetermined or desired efficiency levels. Building conditions may change during use, such as, for example, when building operators modify building operations, with daily fluctuations in use, or with daily fluctuations in environmental conditions, such as temperature. Such changes may lead to drifts in energy efficiency. While building modifications and retrofitting may reduce drift, such modifications may be time consuming and costly, making them impractical in at least certain circumstances.

### SUMMARY OF THE INVENTION

In an aspect of the invention, a method for displaying analyzed energy data comprises collecting operational data corresponding to building equipment from a facility, the operational data having one or more operational data values; inputting energy or other building state data into a cell among a matrix of cells for intensity transform analysis, each cell in the matrix of cells distributed as a function of a first dimension and second dimension, the first dimension being a first unit time; ascribing to each energy data a visual indicator based on one or more predetermined threshold energy values, thereby generating visual indicators associated with the energy data; overlaying the visual indicators on the matrix of cells; and displaying the matrix of cells overlaid with the visual indicators.

In one embodiment, a computer-implemented method for collecting, analyzing and displaying energy consumption data associated with a facility comprises collecting operational data corresponding to building equipment (e.g., electrically and/or gas operated equipment) from a facility; feeding the operational data into a cell among a matrix of cells for intensity transform analysis, each cell in the matrix of cells distributed as a function of a first dimension and second dimension, the first dimension being a first unit of time; ascribing to each operational data a visual indicator based on one or more predetermined threshold operational data values, thereby generating visual indicators associated with the operational data; overlaying the visual indicators on the matrix of cells; correlating the operational data with one or more factors internal or external to the facility; displaying the matrix of cells overlaid with the visual indicators to generate a plot showing the energy consumption of the facility as a function of the first dimension and the second dimension.

In another embodiment, a computer-implemented method for managing resources within a facility comprises collecting operational data from the facility; providing the operational data into a cell among a matrix of cells for intensity transform analysis, each cell in the matrix of cells distributed as a function of a first dimension and second dimension, the first dimension being a unit of time; analyzing the operational data; and generating a plot having a first axis along the first dimension and a second axis along the second dimension.

In another embodiment, a method for managing energy consumption within a facility, comprises collecting an energy data point from the facility; providing the energy data point into a cell among a matrix of cells, each cell in the matrix of cells distributed as a function of a first dimension and second dimension, the first dimension being time; performing off-hour analysis of the energy data, the off-hour analysis comprising comparing the energy data point to an analytically generated threshold value and flagging the energy data point if the energy data point is above the threshold value; and generating a plot having a first axis along the first dimension and a second axis along the second dimension.

In another embodiment, a method for displaying energy use within a facility comprises collecting a first energy data point from the facility; providing the first energy data point into a first cell, the first cell among a matrix of cells distributed as a function of a first dimension and second dimension, wherein the first cell is at a first incremental unit along the first dimension and a first incremental unit along the second dimension; comparing the energy data point to a threshold value; collecting a second energy data point from the facility; providing the second energy data point into a second cell, wherein the second cell is at a second incremental unit along the first dimension and the first incremental unit along the second dimension, the second incremental unit of the first dimension adjacent the first incremental unit of the first dimension; and generating a plot of energy use for the facility, the plot having a first axis along the first dimension and a second axis along the second dimension.

In another embodiment, a method for displaying energy data comprises collecting energy consumption data from a facility; storing each energy consumption data into a cell among a matrix of cells for intensity transform (or spectral) analysis, each cell in the matrix of cells distributed as a function of a first dimension and a second dimension, the first dimension being time; and generating a plot having a first axis along the first dimension and a second axis along the second dimension.

In another aspect of the invention, a system for displaying energy use for a facility comprises an energy collection module for collecting energy usage data from an energy gateway module in a facility; a cell module communicatively coupled to the energy collection module, the cell module for providing energy data from the energy collection module into a cell among a matrix of cells, each cell in the matrix of cells distributed as a function of a first dimension and second dimension; and a plot module communicatively coupled to the cell module, the plot module for generating an energy plot using energy data from the cell module, the energy plot having a first axis along the first dimension and a second axis along the second dimension.

In another embodiment, a system for displaying operational data for a facility comprises an operational data collection module for collecting operational data from a gateway module communicatively coupled to a facility; a cell module communicatively coupled to the operational data collection module, the cell module for providing operational data from the operational data collection module into a cell among a matrix of cells, each cell in the matrix of cells distributed as a function of a first dimension and second dimension; an analysis module, the analysis module for analyzing the operational data in the matrix of cells; and a graphical user interface (GUI) for intensity transform analysis, the GUI for generating an operational data plot using operational data from the cell module, the operational data plot having a first axis along the first dimension and a second axis along the second dimension.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The patent or application file contains at least one drawing executed in color. Copies of this patent or patent application publication with color drawings will be provided by the Office upon request and payment of the necessary fee.

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 schematically illustrates a matrix of cells, in accordance with an embodiment of the invention;

FIG. 2 schematically illustrates a method for analyzing and displaying operational data from a facility, in accordance with an embodiment of the invention;

FIG. 3 illustrates an energy consumption (or usage) matrix, in accordance with an embodiment of the invention. The matrix on the left is a magnified portion of the plot on the right;

FIG. 4 illustrates an energy matrix overlaid with a visual indicator, in accordance with an embodiment of the invention. The left-most matrix is a blow-up of the designated portions of the right-most and middle matrices. Numerical energy (kW) values in the middle matrix have been precluded from the right-most matrix;

FIG. 5 illustrates an energy plot, in accordance with an embodiment of the invention. Various anomalies have been indicated in the figure;

FIG. 6 illustrates a demand spectrum (top) and a plot of an energy matrix overlaid with the demand spectrum (bottom), in accordance with an embodiment of the invention;

FIG. 7 illustrates a power (or energy use) spectrum showing normal use and anomalous use, in accordance with an embodiment of the invention;

FIG. 8 illustrates a matrix showing a prediction of energy consumption (top) and a plot showing a comparison of the prediction to actual building (or facility) data (bottom), in accordance with an embodiment of the invention;

FIG. 9 illustrates a matrix in which outlier patterns have been identified, in accordance with an embodiment of the invention;

FIG. 10 illustrates a matrix having visual indicators to show fault and non-fault conditions, in accordance with an embodiment of the invention;

FIG. 11 illustrates an intensity transform system, in accordance with an embodiment of the invention;

FIG. 12 illustrates a graphical user interface (GUI) associated with an intensity transform system, in accordance with an embodiment of the invention;

FIGS. 13 and 14 show functional block diagrams of general purpose computer hardware platforms for use with intensity transform analysis systems, in accordance with embodiments of the invention;

FIG. 15 shows an energy plot in column plot format, in accordance with an embodiment of the invention;

FIG. 16 illustrates an example of a time-series trend of raw electrical meter data, in accordance with an embodiment of the invention;

FIG. 17 illustrates an example of a temperature trend, in accordance with an embodiment of the invention; and

FIG. 18 illustrates an electricity cost spectrum (or electricity intensity transform graph), in accordance with an embodiment of the invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The term “operational state,” as used herein, may refer to a state corresponding to the operation of a unit, building or facility. The operational state of a building or facility may include the utility consumption and/or usage of the building or facility, including one or more of energy use, electricity use, gas (e.g., natural gas) use, water use, and data use (e.g., network, cable, phone). Operational data is data related to an “operational state” of a unit, building or facility.

The term “intensity transform”, as used herein, may refer to a visual representation of data, such as data among a set of data (e.g., a matrix of data). As one example, a visual representation may include a graphical representation of data (e.g., heat map, color-coded plot, column plot, bar plot). An intensity transform may be generated by mapping data to a visual representation of the data. For example, data may be mapped from a data space to an image (or visual) space. Such mapping may be accomplished with the aid of a mapping table (e.g., a particular color for data within a predetermined range of data) or other mapping algorithms. An intensity transform may enable a user to assess a value, order or magnitude of a particular data in relation to other data, such as data in a cell among a matrix of cells.

The term “intensity transform analysis”, as used herein, may refer to data analysis with the aid of an intensity transform plot or matrix. Intensity transform analysis may include operational data analysis with the aid of an intensity transform plot or matrix. Operational data analysis may include utility usage or consumption analysis, such as energy usage or consumption analysis. In some embodiments, intensity transform analysis may include spectral analytics. In some cases, intensity transform analysis may include spectral analysis.

In embodiments, intensity transform methodologies allow for the rapid assessment of high resolution energy data. Energy data may correspond to the energy consumption of a facility or some subset of a facility. In some embodiments, intensity transform methodologies may permit large data sets to be viewed and analyzed in a single graphic without any loss of data resolution. The flexibility of the methodology may be applied to other types of analysis as well. The intuitive layout of intensity transform methodologies may facilitate or enhance rapid pattern recognition, correlation between data variables, and anomaly detection. The end result may provide an energy analyst with a simple, comprehensive energy fingerprint of an asset and an energy consumption profile. This may advantageously provide for increased energy savings.

In some situations, to create an energy fingerprint or any other intensity transform image, raw or processed data may be fed (or provided) into a matrix where each cell contains the appropriate value and is visually-coded (e.g., color-coded) according to some predefined or predetermined criteria. The resulting image may match the resolution of the available data, thereby minimizing, if not eliminating, data from being lost or obscured by the process.

### Intensity Transform Methods

In an aspect of the invention, a computer-implemented method for managing resources within a facility comprises using a computer system to collect operational data points from the facility (such as a building). Such a method may be used to manage energy consumption within the facility, in which case operational data collected from the facility may include, without limitation, energy use data. Next, the operational data (also “operational data points” herein) is provided (or inputted) into a cell among a matrix of cells, each cell in the matrix of cells distributed as a function of a first dimension and second dimension, the first dimension including a first unit of time. The operational data may be provided sequentially or in a batch-wise fashion. Next, the operational data points are analyzed and transformed. The operational data points may be analyzed by comparing each operational data point to a threshold value and flagging the operational data point if the operational data point is above the threshold value. In some situations, off-hour analysis may be performed on each of the operational data points, the off-hour analysis comprising comparing each operational data point to a threshold value determined from the operational state of the building, facility, or subsystem during an off-business-hours or unoccupied state. Following the off hours analysis, operational data points are flagged if the operational data point is above the threshold value. A plot is then generated having a first axis along the first dimension and a second axis along the second dimension. The second dimension may include a second unit of time, location, equipment (e.g., HVAC units, meters, valves), or select portions of a facility, such as one or more rooms of the facility. In such fashion, a plot (or intensity transform plot or matrix) may be generated showing, for example, energy patterns or trends over the period of a day and across weeks, months or years, or, alternatively, across a facility or select equipment. The intensity transform graph may be displayed to a user to readily pinpoint anomalies and faults.

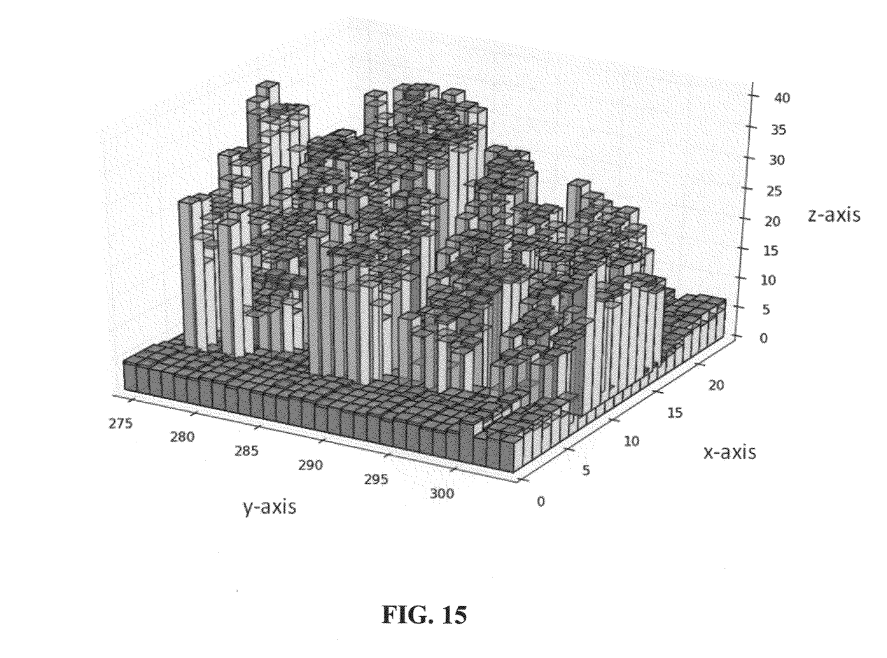

A plot may be selected from a three dimensional plot, a pseudo three dimensional plot (e.g., three dimensional column plot), and a color-coded plot, in addition to other representations, such as, for example, XY scatter plot, bar plot, column plot (see, e.g., FIG. 15 and accompanying text). A three-dimensional plot may include a third dimension orthogonal to the first and second dimensions.

Operational data points may be selected from energy consumption data (e.g., kilowatts, kilowatt hours), gas or electric meter values, temperature, heating rate, cooling rate, electrical load, thermal load, heat loss, and various mechanical parameters, such as valve positions or operating conditions.

Intensity transform methods may be used to assess the energy consumption of a facility. In one embodiment, a computer-implemented method for collecting, analyzing and displaying energy data comprises collecting energy data, such as energy consumption data, from a facility or facility subsystem. The energy data may then be stored in a cell among a matrix of cells for intensity transform (or spectral) analysis, each cell in the matrix of cells distributed as a function of a first dimension and a second dimension, the first dimension including a first unit of time. From the matrix of cells a plot may be generated, the plot having a first axis along the first dimension and a second axis along the second dimension.

A visual indicator may be ascribed to each energy data value based on one or more predetermined threshold energy values, thereby generating visual indicators associated with the energy data. The visual indicators may be overlaid on the matrix of cells, and the matrix of cells overlaid with the visual indicators may be provided for display to a user.

In some cases, the energy data is stored in the matrix of cells for operational data (or intensity transform) analysis as it is collected. In other cases, providing energy data into a cell among a matrix of cells comprises providing energy data into cells that are sequentially oriented along the first dimension.

In some embodiments, data analysis may be performed using data from the matrix of cells. Data analysis may include one or more of modeling, fault analysis, consumption analysis, base load analysis, off-hour analysis, on-peak and off-peak analysis, real-time pricing, future pricing, operational set point analysis and trend analysis.

In another embodiment, a method for analyzing and displaying operational data comprises using a computer system to collect operational data corresponding to equipment (also “facility equipment” herein) from a facility. Equipment may include electrically operated equipment, gas operated equipment (e.g., equipment operated on hydrocarbon-containing fuels, such as natural gas or propane). Equipment may be disposed in, or associated with, an operational unit, such as a building or facility. In some embodiments, operational data may include energy consumption (or energy usage) data.

Next, an operational data value is stored or fed (or inputted) into a cell among a matrix of cells for intensity transform analysis, each cell in the matrix of cells distributed as a function of a first dimension and a second dimension, the first dimension including a first time. The operational data value may be stored on a computer system or database. Another operational data value may be stored or fed into another cell among the matrix of cells, and so on.

In some cases, an operational data value may be fed into the matrix of cells as it is collected. In other cases, the operational data value may be fed into the matrix of cells in a batch-wise fashion.

The first dimension may include a first time, such as a non-repeating (or non-cyclic) range of time, such as seconds (e.g., second one to second sixty range), minutes (e.g., minute one to minute sixty range), hours (e.g., hour one to hour twenty four range), time of day, day of month, or month of year. The second dimension may include a second time, date or location. The first dimension and the second dimension may both be time dimensions. The second dimension may be a dimension of time at a larger scale than the second dimension. For example, the first dimension may be a time dimension on the order of minutes—such that data along the first dimension is inputted on the basis of minutes—and the second dimension may be a time dimension on the order of days—such that data along the second dimension is inputted on the basis of days. The second dimension may include a non-repeating (or non-cyclic) range of time. For example, the matrix of cells may include rows and columns of a first time (seconds, hours, or minutes) and second time (days, weeks, months, or years). Alternatively, the second dimension may be a location, such that the matrix of cells permits storage of operational data among a plurality of locations at a particular point in time.

The matrix of cells may be stored on a memory location of the computer system or another computer system, such as a database. A plot having a first axis along the first dimension and a second axis along the second dimension may then be generated. The plot may then be presented for display by a user.

A visual indicator may be ascribed to each data point in the plot. The visual indicator may be ascribed to each data point based on analysis against one or more predetermined threshold operational data values, thereby, generating visual indicators associated with the operational data. In some embodiments, ascribing to each operational data a visual indicator comprises ascribing to each operational data a number that is a fraction or percentage of the one or more predetermined threshold operational data values. In other embodiments, the operational data values are normalized (see below). Next, the visual indicators may be overlaid on the matrix of cells. The matrix of cells overlaid with the visual indicators may then be displayed.

In some embodiments, one or more operational data values having predetermined values (e.g., predetermined energy value, power value, energy consumption value) may be flagged or marked for review by a user. In some cases, such flagged operational data may be associated with an alert, notification, or user generated comment, such as an audible or visual alert, to enable a user to readily view the flagged operational data. In other cases, a flagged visual indicator, such as a predetermined color, is provided with each flagged operational data (e.g., energy data). The flagged visual indicator may be different from visual indicators ascribed to the other (non-flagged) operational data. The intensity transform analysis system may then display the matrix of cells overlaid with the visual indicators. In some cases, the system may display a flagged visual indicator along with a visual indicator provided to each operational data. For example, if energy consumption data is provided with certain colors, ranging from green to red, the flagged operational data may be provided with a unique visual indicator, such as a symbol (e.g., pseudo three dimensional flag).

Visual indicators may be selected from colors or symbols. In such case, the plot may be a color-coded plot. In other cases, visual indicators may be presented as bars, such as in a pseudo-three dimensional plot (or bar graph). In some cases, visual indicators may be color-coded with the aid of a color gradient, such as a gradient of color extending from blue to red. For example, red may correspond to a certain operational data condition (e.g., high or undesirable energy consumption) and green may correspond to another operational data condition (e.g., low or desirable energy consumption).

Visual indicators may be selected from color, texture, contrast, pattern, and cell (or pixel) shape, size, or orientation. In other cases, sound may be used in place of visual indicators, such as an audible alert when a predetermined threshold has been reached among data in a matrix of cells.

In embodiments, operational data in a matrix of cells may be overlaid with a calendar, a schedule, alerts or other correlating factors (see below).

Operational data may include electrical operational data, such as kilowatts (kW), kilovolt ampere (kVA), kilowatt hour, (kWh), power factor, voltage, and frequency. Operational data may be gathered from a facility (or building), such as various units or unit operations in a facility, including one or more HVACs, flow meters, valves, or heating units. Operational data may include one or more of flow rates, volume, gas concentration, temperature, heat use (e.g., BTU), heat loss, occupancy, electricity use, requests, heating requirements, cooling requirements, and complaints.

In embodiments, operational data points may be processed, analyzed or both. For example, an analysis system or module may correlate facility energy use with external or internal factors (i.e., external or internal to the facility) to enable a user to assess whether visual anomalies are due to external or internal factors. In some cases, the analysis system or module may provide off-hour analysis of operational data.

In some embodiments, operational data, such as energy consumption data, may be analyzed by performing one or more of modeling, fault analysis, consumption analysis, base load analysis, off-hour analysis, real-time pricing and trend analysis, error analysis, and predictive modeling. In predictive modeling, energy consumption characteristics over a certain time period may be used to predict energy consumption characteristics over a future time period. In some situations, operational data may be correlated with other data, such temperature trends or modeling trends (see below).

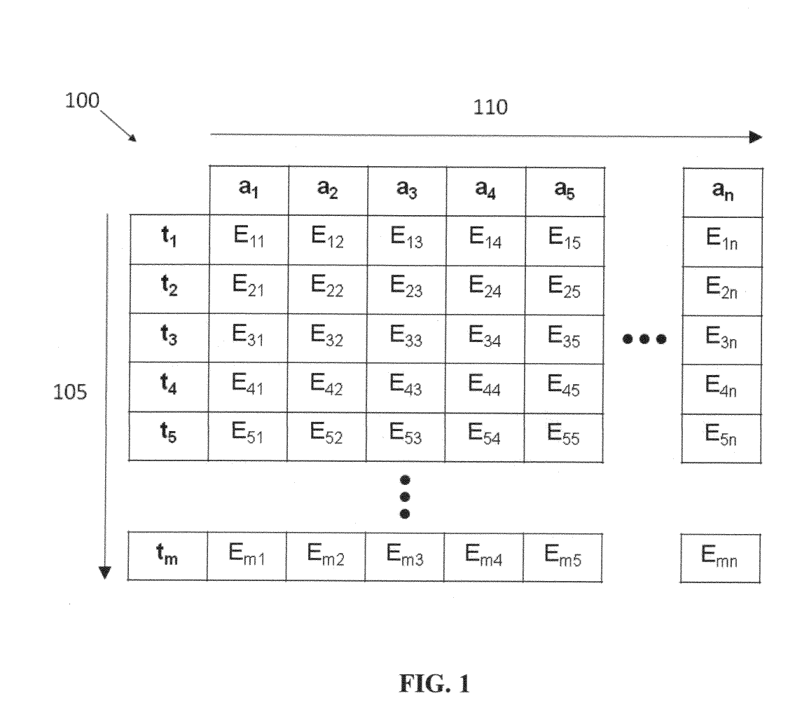

In embodiments, a computer-implemented method for displaying energy use within a facility comprises collecting a first energy data point (or other operational data point) from the facility. Next, the first energy data point may be provided into a first cell, the first cell among a matrix of cells distributed as a function of a first dimension and second dimension (see, e.g., FIG. 1 below), wherein the first cell is at a first incremental unit along the first dimension and a first incremental unit along the second dimension. The energy data point may be compared to or analyzed against a threshold value, such as a predetermined (or user-defined) threshold value. A second energy data point may then be collected from the facility. The second energy data point may then be provided into a second cell, wherein the second cell is at a second incremental unit along the first dimension and the first incremental unit along the second dimension, the second incremental unit of the first dimension adjacent the first incremental unit of the first dimension. A transform plot (or matrix) of energy use for the facility may then be generated, the plot having a first axis along the first dimension and a second axis along the second dimension.

Next, a third energy data point may be collected from the facility. The third energy data point may then be provided into a third cell, the third cell being disposed at a first incremental unit along the first dimension and a second incremental unit along the second dimension.

In some embodiments, a plot may be generated by ascribing to each energy data a visual indicator based on one or more predetermined threshold energy values, thereby generating visual indicators associated with the energy data. Next, the visual indicators may be overlaid on the matrix of cells. The matrix of cells overlaid with the visual indicators may then be displayed to a user.

FIG. 1 shows a matrix of cells 100 having individual cells oriented along a first dimension 105 and second dimension 110, in accordance with an embodiment of the invention. The first dimension 105 includes a first unit of time, tₘ, wherein is an integer greater than 1, and the second dimension 110 includes aₙ, which may be another variable, such as a second unit of time, wherein ‘n’ is an integer greater than 1. The first dimension 105 may be distributed in sequence, from t₁ to t₅, with t₅ being a later time than t₁. The times tm may be on the order of seconds, minutes, hours, days, weeks, months or years. Each cell may include an energy data point, Eₘₙ. For example, the cell at time t₁ and second dimension a₁ may include energy data point E₁₁. In an alternative embodiment, any operational data point may be provided in each cell. For example, the cells may include heating rates or operational set points.

With continued reference to FIG. 1, data points are provided in the matrix of cells 100 along the first dimension 105 for a particular unit along the second dimension 110. For example, energy data points may be provided in the order E₁₁, E₂₁, E₃₁, E₄₁, E₅₁ to Eₘ₁. Next, energy data points may be provided in the order E₁₂, E₂₂, E₃₂, E₄₂, E₅₂ to Eₘ₂. That is, for a particular unit along the second dimension 110, cells along the first dimension 105 are occupied.

With continued reference to FIG. 1, the cells among the matrix of cells 100 may be occupied by data as the data is collected from a facility. Alternatively, the data may be stored and provided to the matrix of cells 100 after collection.

The data stored in the matrix of cells 100 may be raw data (e.g., raw energy data) or processed data (e.g., processed energy data). In some instances, data may be processed to remove any anomalies (e.g., negative or otherwise outlier energy values) prior to entry into the matrix of cells 100. In other instances, data may be normalized, such as with respect to a particular data point (e.g., a data point having the highest value) or with respect to a mean or median of the data points. In other instances, data may be processed to provide standard deviations in each cell or to show historic maxima and/or minima. The matrix of cells 100 may thus be occupied by raw data or data that has been processed based on predetermined criteria.

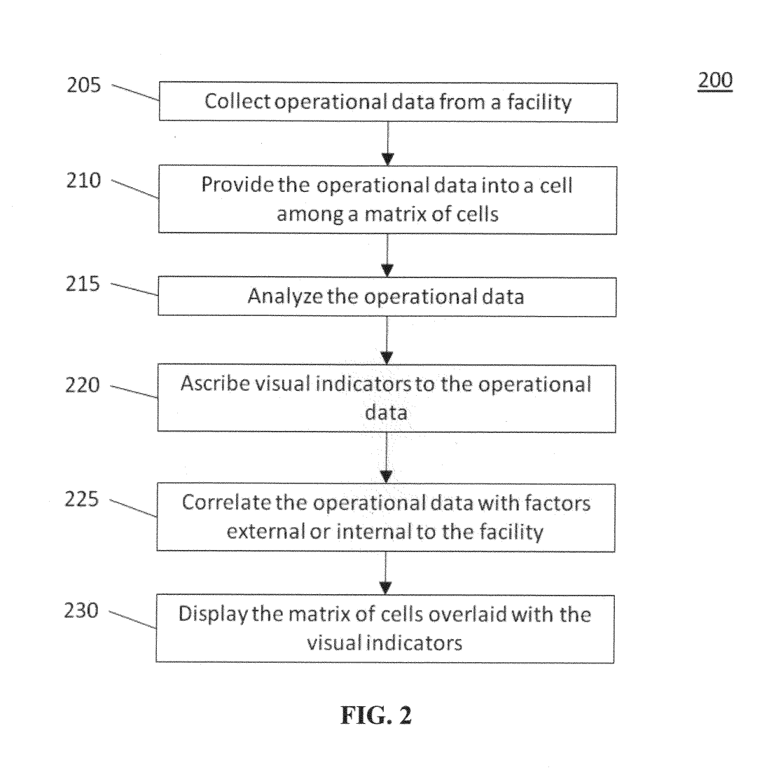

FIG. 2 shows a method 200 for collecting, analyzing and displaying operational data from a facility, in accordance with an embodiment of the invention. The operational data may correspond to the energy consumption of the facility. In a first step 205, operational data is collected from a facility with the aid of an intensity transform analysis system (see below). Next, in a second step 210, the operational data may be provided into a cell among a matrix of cells. Next, in a third step 215, the operational data may be analyzed according to any of the methods provided herein. In some cases, the third step 215 may be precluded, performed before the second step 210, or performed at a later time. Next, in a fourth step 220, visual indicators may be ascribed to each of the operational data. In some embodiments, in a fifth step 225, the operational data may be correlated with one or more factors that are external to the facility and/or internal to the facility, such as, for example, external temperature or energy demand. Next, in a sixth step 230, the matrix of cells overlaid with the visual indicators is displayed to a user. In an alternative embodiment, the third step 215 may include correlating the operational data (e.g., energy consumption data) with one or more factors internal and/or external to the facility. In such a case, the fifth step 225 may be precluded.

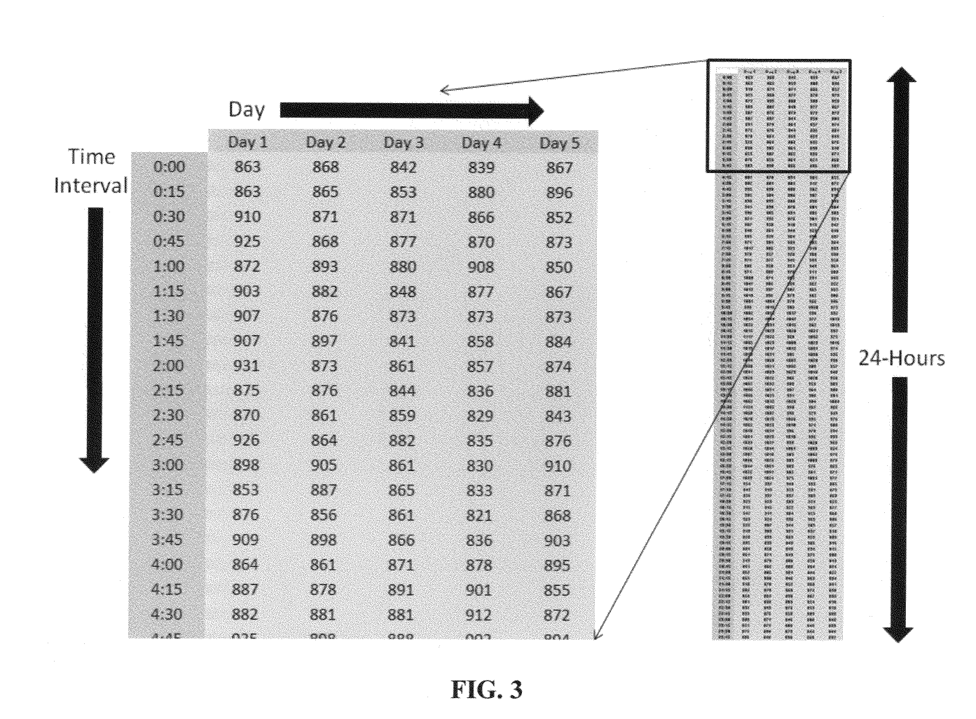

FIG. 3 shows a matrix of cells (“energy matrix”) having energy data (kilowatt values) collected from a facility (e.g., building), in accordance with an embodiment of the invention. Each column represents a single day and each row corresponds to an interval to which the particular data point belongs. The figure on the left is a magnified portion of the figure on the right, which shows energy data collected over a period of 24 hours.

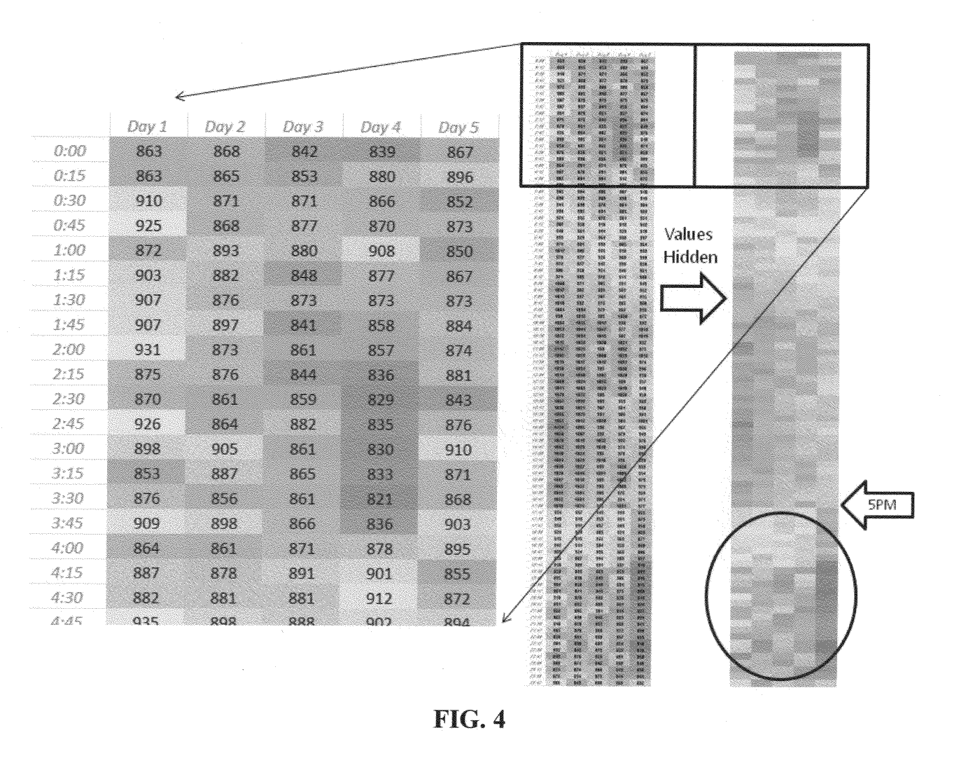

With reference to FIG. 4, with a matrix of cells established as in FIG. 3, the system overlays the matrix with a color scheme generated via an intensity transform to provide a visual indication, which may aid in analysis. The matrix having the color scheme (or visual indicators) may then be displayed to a user. Adding an initial color scheme to the matrix gives a first glimpse into the energy intensity. In some embodiments, a color scheme may be applied to the matrix of cells, where lower numerical values may appear green, middle numerical values may appear yellow, and high numerical values may appear red. In some cases, numerical values below a predetermined threshold value may be associated with (or overlaid by) one color (e.g., green), and numerical values above the predetermined threshold value may be associated with another color (e.g., red).

With continued reference to FIG. 4, the matrix of cells overlaid with a visual indicator may permit a user (e.g., analyst) to view one or more operational patterns, such as, for example, usage patterns or anomalies associated with equipment failure (e.g., cooling system failure). Cells associated with an increased demand for energy appear lighter (toward the red end of a color spectrum) than cells associated with a decreased (or lower) demand for energy, which may have a color toward the green end of the color spectrum. For example, at about 5 PM, there is a clear drop in power consumption, likely due to the drop in operational state of the heating, ventilating and air conditioning (HVAC) system. This is indicated by the oval in the left-most figure, in which cells appear lighter in color then cells above. In contrast, viewing the same data in a two-dimensional line graph or table may not allow for such a ready assessment.

With continued reference to FIG. 4, by providing energy (or other operational data) throughout the day and across several days, the system may enable a user to assess times of day in which there is a high demand for energy. In addition, the system may enable a user to determine faults in the system, such as faults in a heating or cooling system of the facility.

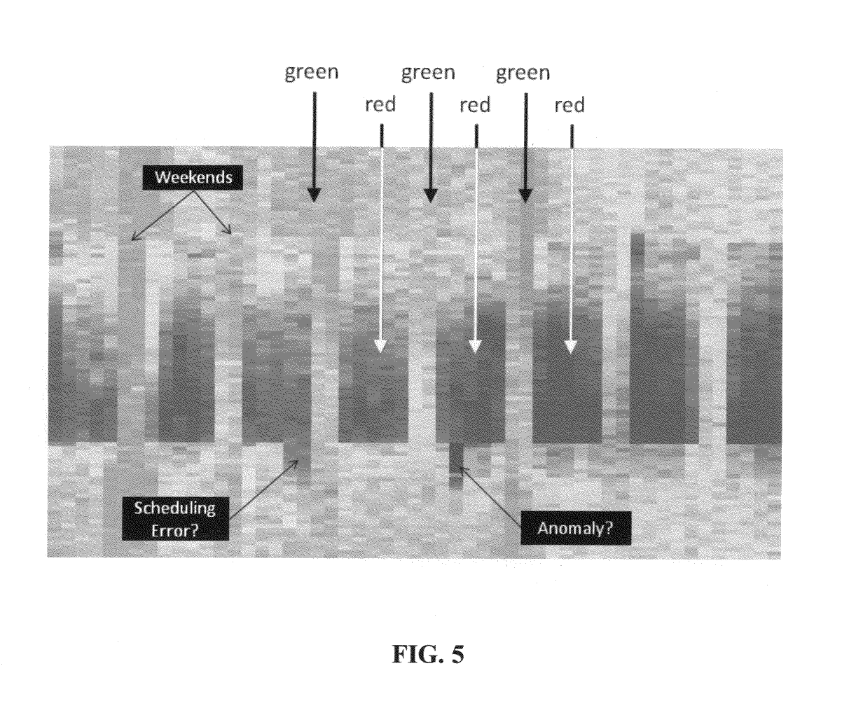

Extending the length of time may enable new analytical possibilities. With reference to FIG. 5, 53 days of raw kW meter data for Building X was gathered and inputted into a matrix of cells. The data was then applied to an intensity transform analysis and overlaid with visual indicators, as described above, and displayed to a user. The figure provides several analytical features. For example, FIG. 5 shows that energy usage during weekends is lower than weekdays, as cells that are aligned along weekend days are lighter than cells that are aligned along weekday days. In addition the figure shows anomalies, such as a scheduling anomaly and an HVAC system anomaly (e.g., HVAC system failure).

With continued reference to FIG. 5, energy data (kW) collected over a period of 53 days enables a user to view an energy intensity fingerprint associated with the facility from which the data is gathered. FIG. 5 shows a distinction between weekends and weekdays, as well as occupied and off-hour (unoccupied) consumption.

While FIGS. 2-4 show energy (kW) data, other operational data may be displayed, such as processed data, event overlays and correlations. In addition, while FIGS. 2-4 show certain embodiments of intensity transform plots, where each column represents a day in sequence and each row the time of day in 15-minute intervals, other intensity transform methods are possible. For example, the data of FIGS. 2-4 may be applied to any set of time-series data (or data that may be placed into two or more categories, like day and time-of-day). The layout also allows for easy data filtering and visual output manipulation (such as the removal of day subcategories, like holidays or weekends, and the alteration of colors) without changing the fundamental characteristics of the spectrum.

In one embodiment, energy usage data (meter data) may be correlated with other internal and external factors that affect energy consumption. This may enable a user to identify or filter which anomalies are due to the operation of a facility (things that may be optimized or fixed), and anomalies that are due to external factors, such as environmental conditions (e.g., weather).

Internal factors are factors that are internal to a building or facility. Internal factors may include building usage, holidays schedules, building construction, employment, work hours, hours worked within a predetermined time period, and building or facility utility demand, such as energy demand. External factors may include factors that are external to a building or facility. External factors may include utility demand, energy demand (e.g., city energy demand), utility supply, energy supply, the price of electricity, the price of utility-grade water, the price of gas, the price of oil, on-peak hours, off-peak hours, political factors, geopolitical factors, consumer confidence, consumer demand, shareholder confidence, and trade embargos.

For example, energy data collected and inputted in a matrix of cells, such as the matrix of cells 100 of FIG. 1, over a period of days, may be correlated with average daily temperatures. The analysis system may then correlate energy use with average temperature to determine whether any anomalies are due to external factors (such as temperature fluctuations) or internal factors, such as system heating or cooling system malfunction.

For example, an energy matrix may be created by inputting raw or processed energy data into a matrix of cells, such as the matrix of cells 100 of FIG. 1. Energy data may be processed via a variety of methods, such by calculating and providing in each cell a standard deviation or a moving average. Concurrently, other data may be collected, such as temperature data or other operational data. Such other data may be stored in another matrix of cells corresponding to the matrix of cells for energy data. The system may then compare values in the energy matrix against values provided in the other matrix (or plurality of other matrices) to pinpoint anomalies.

Methods provided herein may be combined with, or modified with, various analysis methods. For example, energy data may be analyzed through a variety of approaches, such as regression, neural network or support vector machine (SVM) to prepare a model, which may be compared against actual consumption (normalized to the same conditions, including temperature). Predetermined deviations from the model may be emphasized (or flagged) through, for example, a visual indicator. Additional overlays, like equipments malfunction alerts, may be added to put the intensity transform images into an even greater context. The resulting intensity transform plot may correlate with consumption or schedules, or deviations from the model in the form of waste. The waste may be identified and subsequently remedied, resulting in quantifiable energy savings.

Operational data, such as, e.g., energy data, may be analyzed and processed in a number of ways to determine energy savings opportunities, operational hazards, and anomalies (e.g., operational anomalies). Analysis may include modeling, alerting and fault detection, key performance indicators (KPIs), trends, energy consumption characteristics and energy pricing. Energy data may be analyzed prior to display to a user (such as in the manner of FIGS. 3 and 4), or after. In embodiments, operational data may be analyzed and used to generate visual indicators. An operational matrix, such as an energy matrix, may subsequently be overlaid with the visual indicators to provide an informative display of such data to a user.

In embodiments, a plot generated from operational data may be overlaid with one or more plots generated from modeling, trending, KPIs and energy (or utility) pricing. For example, an energy matrix having visual indicators to show energy user above or below certain predetermined thresholds may be overlaid with a plot showing temperature trends over the same time period. This may enable a user to correlate energy use (or other operational data) with external factors.

In embodiments, energy data may be modeled in a variety of ways in order to determine predetermined (e.g., normal) energy consumption patterns, or predetermined base loads. In some cases, discrepancies from the model are considered anomalies, or undesirable behavior. Different aspects of the model may be displayed using intensity transform analyses. In one embodiment, under energy data normalization, a spectrum of color may be mapped to the position of an energy reading in a demand spectrum. The position (quantified according to the number of standard deviations) of an energy reading in the demand spectrum may be determined by subtracting the average of the energy in the dataset and dividing by its standard deviation.

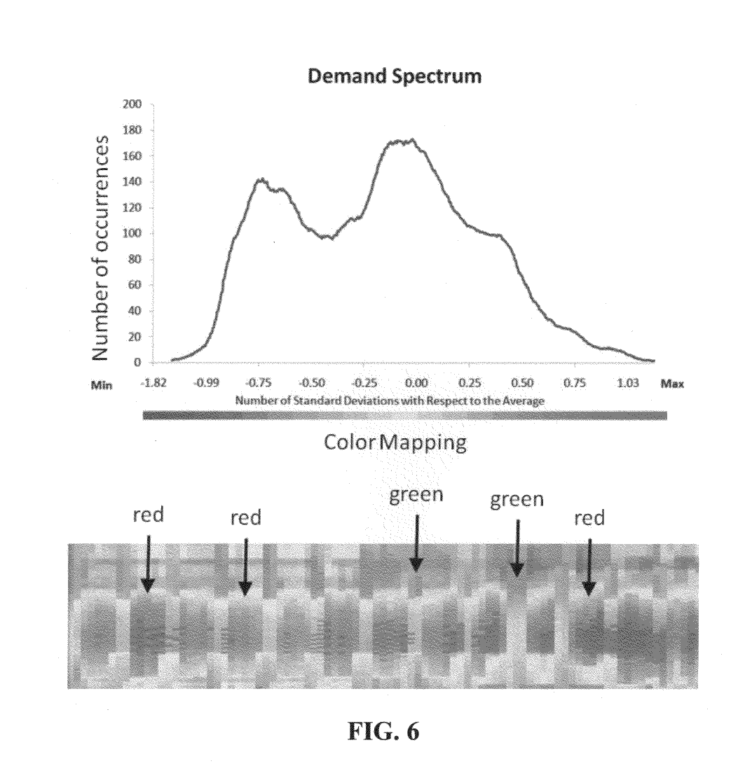

With reference to FIG. 6, in one embodiment, an energy demand spectrum (top) is shown having the number of occurrences on the ordinate and the number of standard deviations with respect to the average on the abscissa. The demand spectrum is used to analyze an energy matrix having energy consumption data, and subsequently used to generate an intensity transform plot (FIG. 6, bottom) having visual indicators with energy values corresponding to high demand having a certain predetermined color (e.g., red or dark grey) and energy values corresponding to low demand a different predetermined color (e.g., green or white). A user may use the demand spectrum to assess energy consumption of a facility as a function of energy demand.

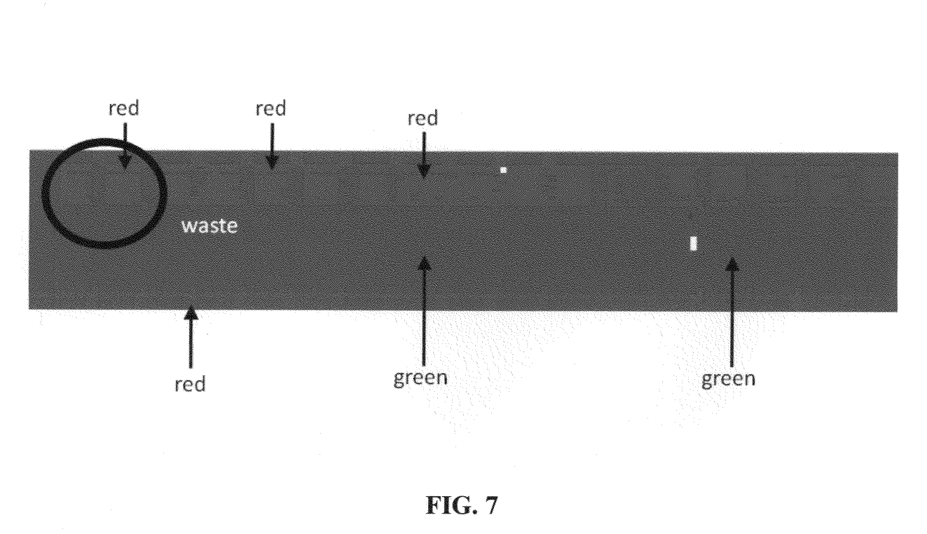

In another embodiment, under off-hour analysis, the base load of a building or facility may be determined. In some cases, operational data from the building may be collected to determine the base load of the building. The base load of the building or facility may be determined using the system and methods described in U.S. patent application Ser. No. 12/805,562, which is entirely incorporated herein by reference. When the demand of the building exceeds that base load and the building is not in use, the user may be advised to check the building's operational equipment, such as, e.g., HVAC and lighting schedules. With reference to FIG. 7, the matrix of cells having energy or operational state data may be analyzed via an intensity transform and overlaid with visual indicators showing “normal” use, in which energy data is overlaid with a first color (e.g., green), and abnormal or anomalous use (or “waste”), in which energy data is overlaid with a second color (e.g., red). Colors are not shown in the grayscale image of FIG. 7. Such visual indicators may permit a user to readily determine anomalies in energy consumption.

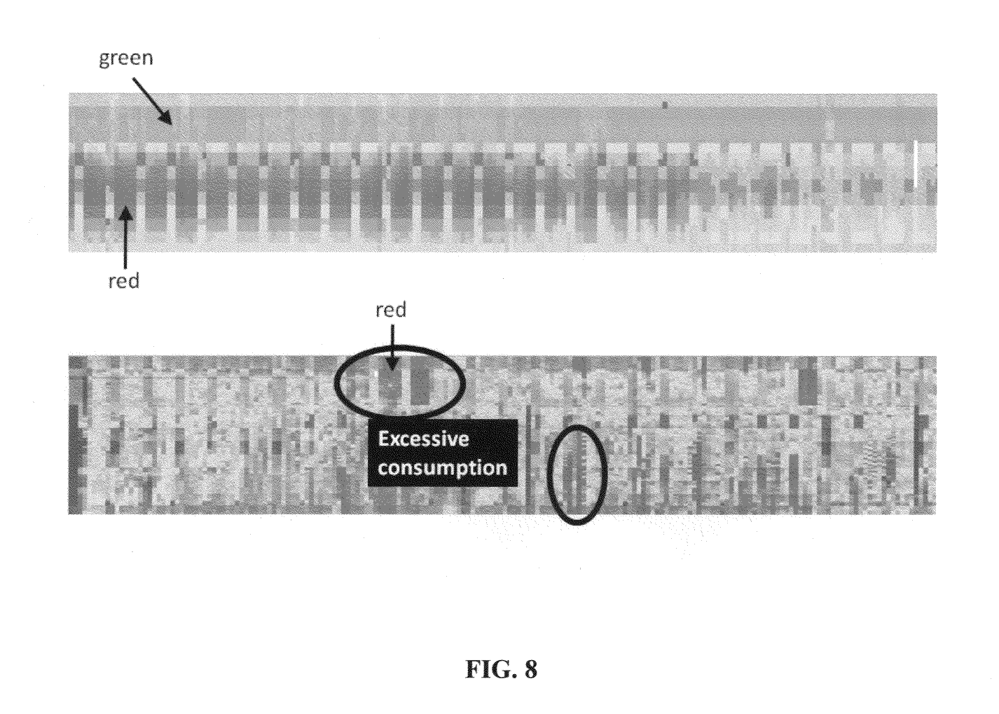

In embodiments, a prediction of energy consumption or baseline may be developed using a variety of methods, such as by simulation, regression, bin models, and/or neural networks. The prediction may subsequently be displayed on a plot having time dimensions along a plane parallel to a display surface, and overlaid with visual indicators. With reference to FIG. 8, top, an intensity transform plot is shown having such predictions. Green and red striations have been indicated in the grayscale image. With reference to FIG. 8, bottom, a model may be compared with the actual building data (as generated in an energy matrix, such as, e.g., the energy matrix of FIG. 3), thus obtaining the error with respect to the model. This may enable a user to find anomalies and identify patterns of excessive consumption. The dark grey or black striations (indicated as red in the figure) may correspond to excessive energy consumption.

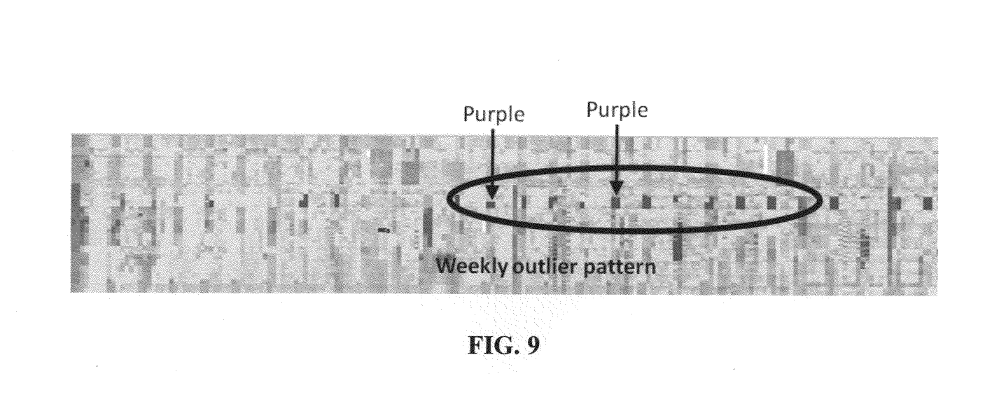

An error with respect to a model used to analyze operational data may be normalized to make anomalies more distinguishable. With reference to FIG. 9, outlier patterns that occur over a weekly time period have been identified in the illustrated intensity graph (or plot).

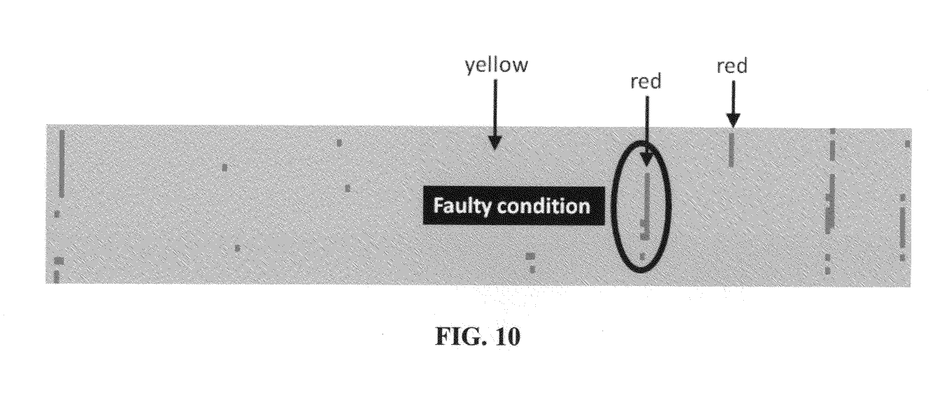

Faulty conditions may be overlaid on a intensity graph (e.g., the graph of FIG. 3). For example, if a chiller cannot meet a set point operational condition during a certain period of time, such fault may be viewed in an intensity transform graph. Faults leading to inefficiencies, such as economizer interlock failure, may be viewed in such a chart. This may permit a user to define conditions that may help determine a fault using a business logic engine, and overlay such predetermined conditions on the intensity graph. With reference to FIG. 10, an intensity transform plot (or spectral graph) having visual indicators to show fault and non-fault conditions is illustrated, in accordance with an embodiment of the invention. Non-fault (or normal) conditions are designated by a first color (e.g., light grey or yellow), and fault conditions are designated by a second color (e.g., dark grey or red). Non-fault conditions may correspond to cases in which a facility is operating to within predetermined operational conditions, and fault conditions may correspond to cases in which the facility is operating outside of (or beyond) the predetermined operational conditions.

Various variables may be trended using spectrums provided herein. The intensity method may be preferable to line graphing since more time-series data may be included in a relatively smaller space. For example, graphing 1 year of 15-minute time interval data may require 35040 unique data points. This may require a graphing space having a width of at least about 35040 pixels to capture the full graphing resolution. Assuming a screen with a resolution of 100 PPI, the screen would have to be over 35 inches wide. In contrast, intensity (or spectral) graphs and methods provided herein may only require a display having a width of about 3.65 inches. Data may advantageously be displayed on more devices, while maintaining full data resolution. In addition, greater context is given to each data point since it may be directly compared to other points that share similar characteristics, like time of day.

Spectrums from multiple trends may be compared against each other (visually or with the aid of an algorithm) to identify correlations. The comparison may also provide context to certain profile characteristics that may emerge from the image.

### Intensity Transform Systems

In another aspect of the invention, an intensity transform system for displaying energy use for a facility is described. The system comprises an energy collection module for collecting energy usage data from an energy gateway module in a facility. The system further comprises a cell module coupled to the energy collection module, the cell module for providing energy data from the energy collection module into a cell among a matrix of cells, each cell in the matrix of cells distributed as a function of a first dimension and second dimension. The system includes a plot module coupled to the cell module, the plot module for generating an energy plot using energy data from the cell module, the energy plot having a first axis along the first dimension and a second axis along the second dimension.

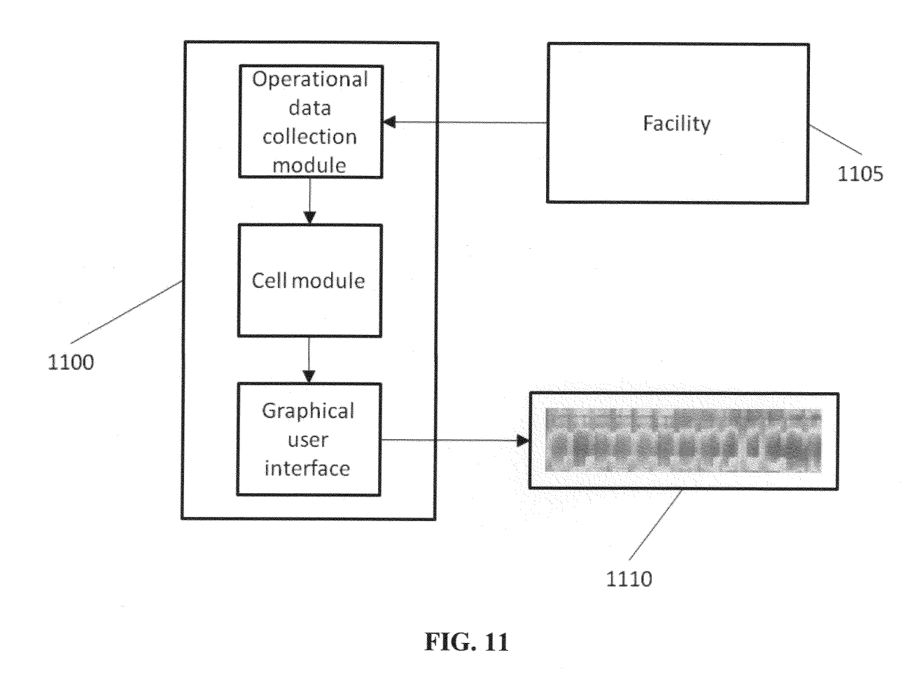

In another aspect of the invention, the intensity transform system is configured to communicate with one or more systems and subsystems, storage units, database(s), an intranet and the interne. In one embodiment, the system includes a one or more subsystems (or modules), such as a storage module, which may include one or more databases. The one or more databases may be for storing operational data, a matrix of cells for intensity transform, or both. FIG. 11 illustrates an intensity transform analysis system 1100 communicatively coupled to a facility 1105 and a display 1110. The system 1100 includes an operational data collection module for collecting operational data from the facility 1105 and directing the operational data to a cell module which includes a matrix of cells (energy matrix in the case of energy data). The system 1100 further includes a graphical user interface for displaying the matrix of cells overlaid with visual indicators (i.e., intensity, such as, e.g., an energy intensity) in the display 1110 for a user. The system 1100 may include an analysis module for analyzing the data provided in the cell module, such as performing off-hour analysis, regression analysis, or modeling (see above). Alternatively, the system 1100 may analyze the data as it is being directed from the operational data collection module to the cell module.

In some situations, the system 1100 may be used for operational data (e.g., utility or energy usage and/or consumption) analysis. Intensity transform (or spectral analytics) information may be used to assess the energy or utility use of a building or facility within a predetermined time period, or compare energy or utility use across one or multiple buildings or facilities at predetermined times.

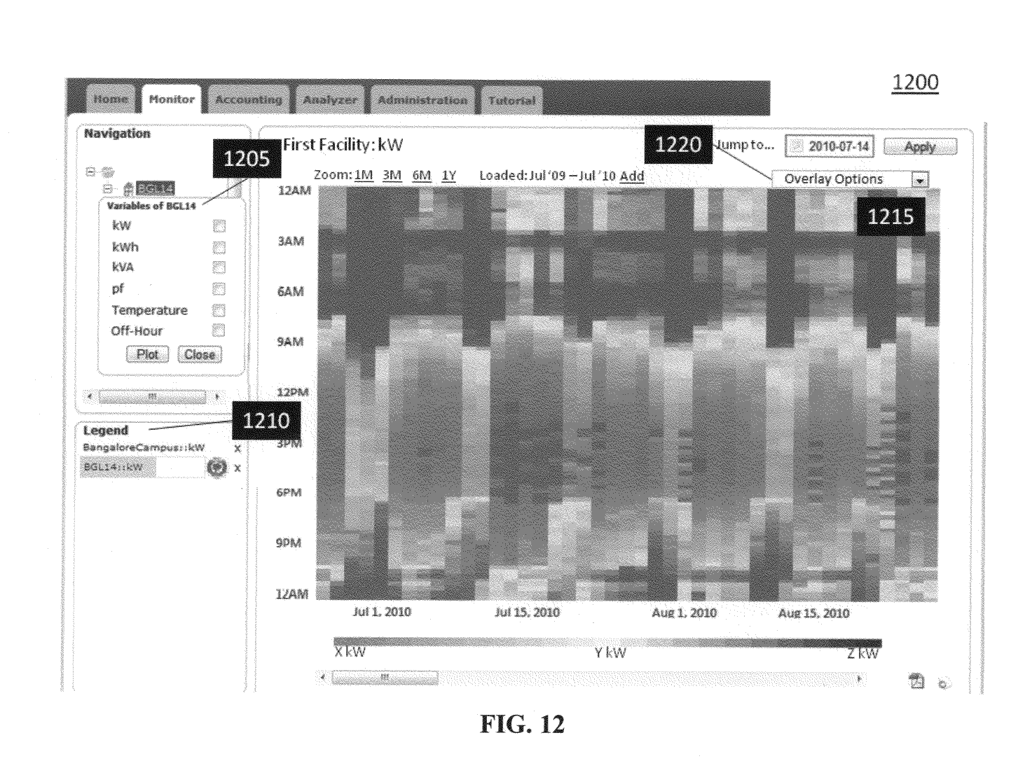

FIG. 12, illustrates a graphical user interface (GUI) 1200 for use with intensity transform analysis systems provided herein, in accordance with an embodiment of the invention. The GUI may be part of an intensity transform analysis system, or part of a system communicatively coupled to the intensity transform analysis system. The GUI 1200 includes a plurality of tabs (“Home”, “Monitor”, “Accounting”, “Analyzer”, “Administration”, “Tutorial”) for permitting a user to access various modules of the intensity transform analysis system. In the illustrated embodiment, the monitor tab is shown. The Analyzer tab may permit a user to perform various analyses on operational data collected from the facility (see above). The home tab may permit a user to view the status of the building or facility as a dashboard, or have a personalized view of the building or facility as a set of key performance indicators (KPIs). The accounting tab may permit a user to track the cost(s) of energy use against a predetermined budget and permit charge-back control. The administration tab may permit a user to Define user settings for alerts and policies. The tutorial tab may permit a user to learn to use the GUI 1200 and various features included in, or associated with, the intensity transform analysis (or spectral analysis) system.

The GUI 1200 may include a variables panel 1205 to enable a user to select from available spectrums (e.g., KW spectrum, KWh spectrum). A legend panel 1210 may permit a user to select loaded spectrums for browsing. An added spectrum may be placed in a loading queue in the legend panel 1210. The GUI 1200 further includes a spectrum 1215, which may be any spectrum described herein. The spectrum is displayed over the period of 24 hours (12 AM to 12 AM) along a first time axis and over a user-defined period along a second time axis. A user may elect to have the spectrum displayed over the period of one month (“1M”), three months (“3M”), six months (“6M”), one year (“1Y”), or other zoom levels, such as n years (“nY”), wherein “n” is a number greater than zero. The GUI may permit a user to zoom in and out of the spectrum (and thus alter the time period of display) with the aid of a pointing device (e.g., mouse, fingers) associated with a computer system displaying the GUI 1200. For example, if the user is viewing the GUI on the user's laptop computer, the user may zoom in and out of the spectrum 1215 with the aid of the user's mouse. As another example, if the user is viewing the GUI 1200 on the user's tablet PC or Smart phone (e.g., iPhone®), the user may zoom in and out with the user of finger gestures. A scroll bar may permit the user to scroll across the spectrum 1215 to view other portions of the intensity transform plot (or “intensity transform matrix”) 1215.

The GUI 1200 may provide a user various overlay options. For example, the user may choose to overlay the intensity transform plot 1215 with an overlay of meter data, error data, occupancy data, service data, notes, or other data, such as temperature data, demand data. In addition, the GUI 1200 may permit a user to adjust a matrix height, such as adjust the height to 96 cells for 15-minute interval data, 48 cells for 30-minute interval data, 24 cells for 1-hour interval data, or adjust the cell height to fit a display area of the GUI 1200. The GUI 1200 may further enable a user to change the manner in which the user views the spectrum. For example, the GUI 1200 may provide a three-dimensional (or pseudo-three dimensional) intensity transform plot for view by a user, or the GUI 1200 may enable a user to select a color gradient, shapes or patterns to ascribe to energy data in a matrix of data, which may be subsequently displayed to the user.

The GUI 1200 may enable various roll-over functionalities. For instance, the GUI 1200 may enable a user to access various operational data information by rolling the user's pointing device over a cell or pixel of the spectrum 1215.

An intensity transform system may associate metadata with operational data. In some cases, upon collecting operational data from a facility, the system may store metadata associated with the operational data. Such metadata may include, for example, a timestamp in which the operational data was collected and information as to the facility or equipment from which the operational data was collected. The GUI 1200 may enable a user to view such metadata upon a mouse roll-over or user selection via a menu option, for example.

The system may include random-access memory (RAM) for enabling rapid transfer of information to and from a central processing unit (CPU), and to and from a storage module, such as one or more storage units, including magnetic storage media (i.e., hard disks), flash storage media and optical storage media. The system may also include one or more of a storage unit, one or more CPUs, one or more RAMs, one or more read-only memories (ROMs), one or more communication ports (COM PORTS), one or more input/output (I/O) modules, such as an I/O interface, a network interface for enabling the system to interact with an intranet, including other systems and subsystems, and the internet, including the World Wide Web. The storage unit may include one or more databases, such as a relational database. In one embodiment, the system further includes a data warehouse for storing information, such energy consumption information and information relating to internal and/or external factors. In some embodiments, the system may include a relational database and one or more servers, such as, for example, data servers.

The system may be configured for data mining and extract, transform and load (ETL) operations, which may permit the system to load information from a raw data source (or mined data) into a data warehouse. The data warehouse may be configured for use with a business intelligence system (e.g., Microstrategy®, Business Objects®).

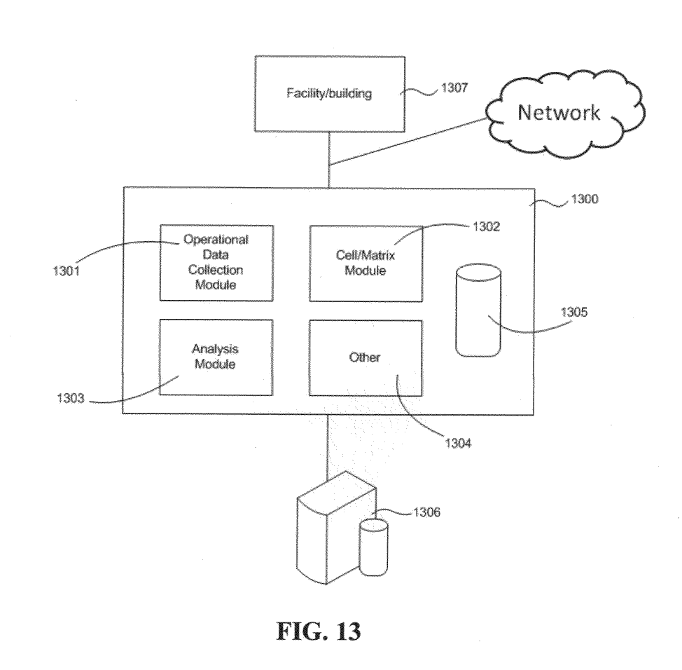

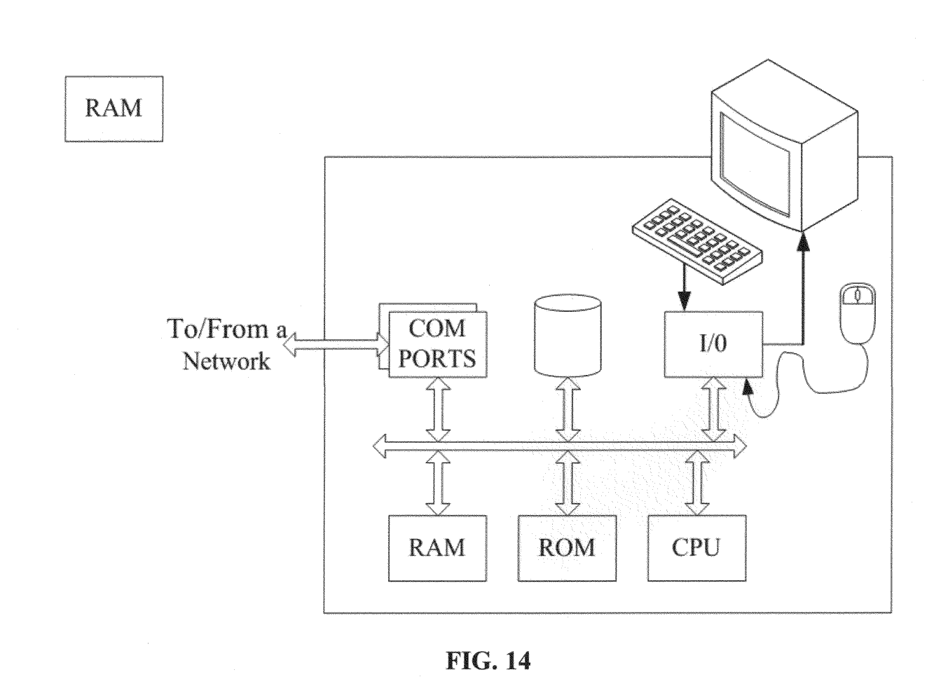

FIGS. 13 and 14 show functional block diagram illustrations of general purpose computer hardware platforms or systems configured for use with intensity transform (or spectral) analysis systems. FIG. 13 illustrates an example of a system, as may be used to implement an intensity transform system, in accordance with an embodiment of the invention. FIG. 14 depicts a computer with user interface elements, as may be used to implement an intensity transform system, including a personal computer or other type of work station or terminal device associated with the system, in accordance with an embodiment of the invention. The computer of FIG. 14 may also act as a server if appropriately programmed. It is believed that those skilled in the art are familiar with the structure, programming and general operation of such computer equipment and as a result the drawings should be self-explanatory.

With reference to FIG. 13, an intensity transform system 1300 may include an operational data collection module 1301, a cell (or matrix) module 1302 and an analysis module 1303. The system 1300 may also include other modules 1304, such as, for example, a visualization module or a graphical user interface (GUI) module for enabling a user to interact with the system 1300, including one or more modules and components of the system 1300.

The system 1300 may include various hardware and software. For example, the system 1300 may include physical storage or server 1305. The system 1300 may be communicatively coupled to another system 1306, which may include physical storage. The system 1306 may be a remote terminal or workstation, which may enable a user to request and view intensity transform graphs.

The system 1300 may be communicatively coupled to a building or facility 1307 with the aid of a communications interface, which may include a wired or wireless interface. The communications interface may communicatively couple the system 1300 to the building or facility 1307 with the aid of the Internet or an intranet.

The system 1300, for example, may include a data communication interface for packet data communication. The system 1300 may also include a central processing unit (CPU), in the form of one or more processors, for executing program instructions. The system platform may include an internal communication bus, program storage and data storage for various data files to be processed and/or communicated by the system 1300, although the system 1300 may receive data via network communications. The hardware elements, operating systems and programming languages of such systems may be conventional in nature, and it is presumed that those skilled in the art are adequately familiar therewith. Of course, the system functions may be implemented in a distributed fashion on a number of similar platforms, to distribute the processing load.

Hence, aspects of the methods outlined above may be embodied in programming. Various aspects of the technology may be thought of as “products” or “articles of manufacture” typically in the form of executable code and/or associated data that is carried on or embodied in a type of machine readable medium. “Storage” type media may include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server or an intensity transform system. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

While certain exemplary intensity transform data has been illustrated as two-dimensional color-coded figures, other graphical representations may be used. In some embodiments, intensity transform information may be illustrated in bar plot, line plot, XY scatter plot, bubble plot, pie plot, area plot, radar plot, ring plot, or column plot format. The plots may be overlaid with other information, such as data average, standard deviation and median numbers. As one example, FIG. 15 illustrates an intensity transform in column format. The height of the columns may correspond to the value (or intensity) of a particular data point. The intensity transform of FIG. 15 includes an x-axis, y-axis and z-axis orthogonal to a plane having the x-axis and y-axis. The numbers on the z-axis correspond to operational data, such as energy or utility usage (or consumption) information. The numbers on the x-axis may correspond to a first time, and the numbers on the second axis may correspond to a second time, location or facility (see above). In the illustrated example, the numbers on the x-axis have units of hours (the x-axis spans a period of twenty four hours), the numbers on the y-axis have units of days, and the numbers on the z-axis are numerical representations of energy use (e.g., kWh).

### EXAMPLES

The following examples are intended to be illustrative and non-limiting. In certain cases reference is made to various colors in the grayscale images accompanying the examples. In some situations, colors have been indicated at select locations on the figures.

### Example 1

Various standard deviation approaches were used to establish the correlations between temperature and overall energy demand in Building X. The development of the iterations in preparing an energy matrix is as follows. In a first iteration, a matrix of cells, such as the matrix of cells 100 of FIG. 1, was filled with values representing the standard deviation of the cell compared to the entire population of cells. This was performed for both the energy matrix and a matrix of cells having temperature data corresponding to a particular cell in the energy matrix (“temperature matrix”). In a second iteration, accuracy was improved by limiting the standard deviation population to calendar months, which negate certain natural seasonal variations. In a third iteration, a moving average approach was implemented that sampled the week before and the week after the corresponding cell. In addition, cells were only compared to other cells for the same time of day. For example, the 3PM reading for Day X was compared to the 3PM readings of Day X−10 through Day X+10. In a fourth iteration, weekends were handled separately from the weekdays for the power matrix.

. Next, the energy matrix was compared the temperature matrix. The corresponding cell values from each matrix were combined to create a third matrix, which showed that 18% of the power fluctuations were inconsistent with variations (or fluctuations) in temperature. However, this particular intensity plot did not quantify the waste, only its frequency.

### Example 2

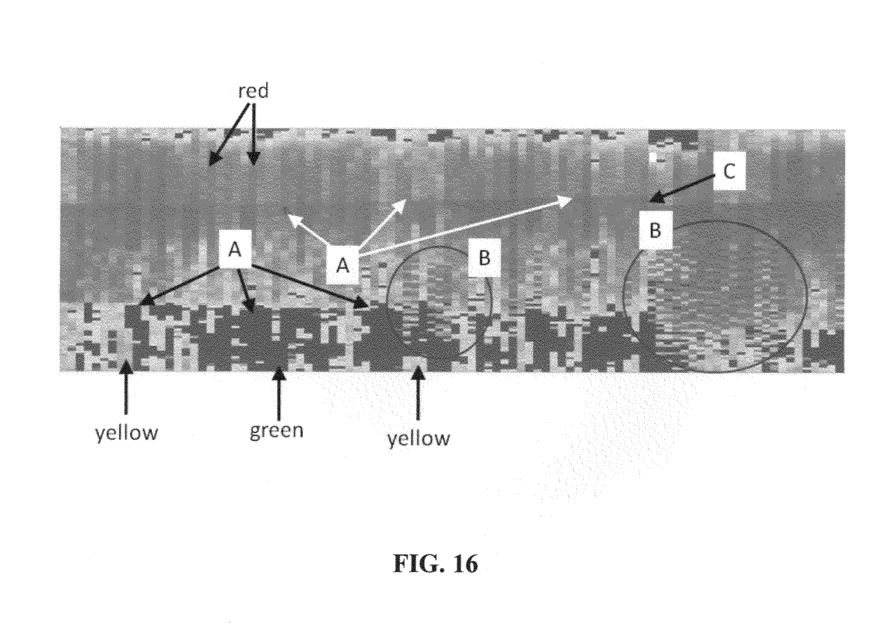

FIG. 16 is an example of a time-series trend of raw electrical meter data. This particular image represents about four months (January 1 to April 6) of power factor data for a dormitory-type building. Red or dark grey bands (or striations) indicate power factor values of 80% or below; yellow or grey bands indicate power factor values of 85%; and green or light grey bands indicate power factor values of 90% or greater. Colors between red, yellow and green (or dark, medium and light grey) indicate power factor values in-between those indicated above. “A” indicates areas in which there are boundaries in the color spectrum that are tied to a building or occupant schedule. A top portion of “A” continues to climb (caused by progressively earlier sunrises) until it dips at March 14, when the clocks were adjusted for daylight savings. In “B”, occurrences of short cycling that were affecting the power factor were observed. Taking action to improve the power factor between the hours of 2 AM and 6 AM to make it look more like 6 PM to 12 AM may provide cost savings to the consumer, who pays a power factor penalty for values below 85%.

### Example 3

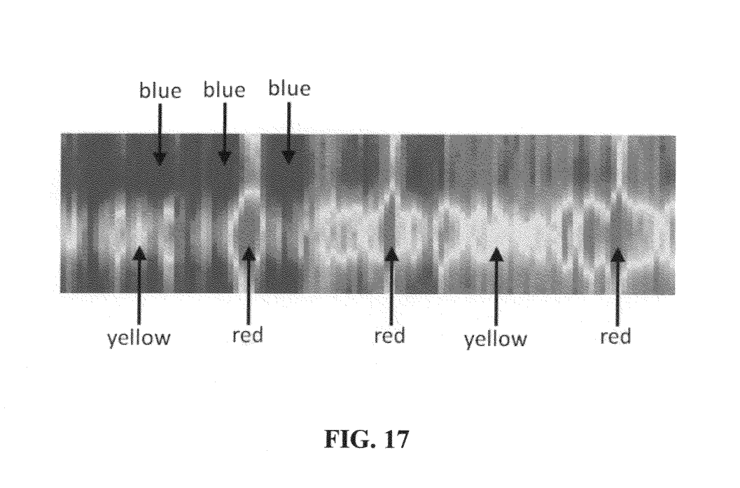

FIG. 17 is an example of a temperature trend, in which blue (or medium gray) indicates temperatures less than 50° F., yellow (or light grey) indicates a temperature of about 70° F., and red (or dark gray) indicates a temperature greater than 90° F. The temperature spectrum of FIG. 1y may be overlaid with another spectrum, such as an energy or power intensity (see FIGS. 3 and 4). This may permit a user to correlate energy consumption or other operational variables with fluctuations in temperature. Other types of temperature display, such as heating-degree days (HDD) or cooling-degree days (CDD), may be used.

### Example 4

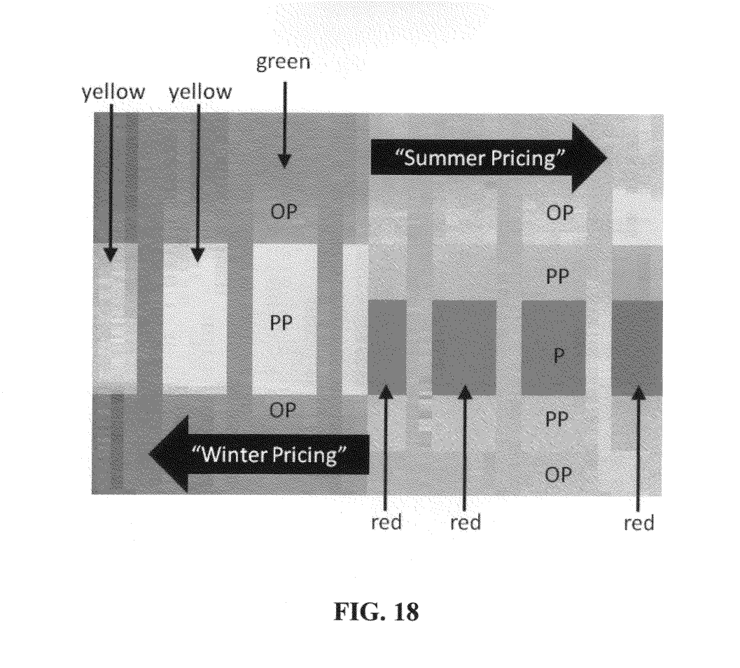

FIG. 18 shows an electricity cost spectrum for a large commercial customer, showing cost incurred from electricity purchases and a utility tariff structure. The left half falls under a winter tariff schedule, where energy prices may be low. The right half falls under a summer tariff schedule, where energy prices may be higher than the winter tariff schedule. The tariff prices are broken down into daily schedules (“P”=Peak, “PP”=Part Peak, and “OP”=Off-Peak), which also correspond to color changes in the cost spectrum.

Systems and methods provided herein may be combined with, or modified by, other systems and methods, such as, for example, systems and/or methods described in U.S. Pat. No. 4,279,026 (“SEISMOGRAPHIC DATA COLOR DISPLAY”), U.S. Pat. No. 6,023,280 (“CALCULATION AND VISUALIZATION OF TABULAR DATA”), U.S. Pat. No. 6,278,799 (“HIERARCHICAL DATA MATRIX PATTERN RECOGNITION SYSTEM”), U.S. Pat. No. 6,304,670 (“COLORATION AND DISPLAY OF DATA MATRICES”), U.S. Pat. No. 6,429,868 (“METHOD AND COMPUTER PROGRAM FOR DISPLAYING QUANTITATIVE DATA”), U.S. Pat. No. 6,711,577 (“DATA MINING AND VISUALIZATION TECHNIQUES”), U.S. Pat. No. 7,250,951 (“SYSTEM AND METHOD FOR VISUALIZING DATA”), U.S. Pat. No. 7,647,137 (“UTILITY DEMAND FORECASTING USING UTILITY DEMAND MATRIX”) and U.S. Pat. No. 7,246,014 (“HUMAN MACHINE INTERFACE FOR AN ENERGY ANALYTICS SYSTEM”); U.S. Patent Publication Nos. 2006/0059063 (“METHODS AND SYSTEMS FOR VISUALIZING FINANCIAL ANOMALIES”) and 2009/0231342 (“METHOD AND APPARATUS FOR ELECTRICAL POWER VISUALIZATION”); and U.S. patent application Ser. No. 12/805,562 (“BUILDING ENERGY MANAGEMENT METHOD AND SYSTEM”), which are entirely incorporated herein by reference.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of embodiments of the invention herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A computer-implemented method for collecting, analyzing and displaying energy consumption data associated with a facility, comprising
collecting operational data corresponding to building equipment from a facility, the operational data having one or more operational data values;
inputting the operational data corresponding to building equipment into a cell among a matrix of cells for intensity transform analysis, each cell in the matrix of cells distributed as a function of a first dimension and a second dimension, the first dimension being a first unit of time;
ascribing to each operational data value a visual indicator based on one or more predetermined threshold operational data values, thereby generating a visual indicator associated with each operational data value;
overlaying the visual indicators on the matrix of cells;
correlating the operational data with one or more factors internal or external to the facility that may impact an operational state of the facility; and
displaying the matrix of cells overlaid with the visual indicators to generate a plot showing the operational state of the facility as a function of the first dimension and the second dimension.

2. A computer-implemented method for managing resources within a facility, comprising:
collecting operational data from the facility;
providing the operational data into a cell among a matrix of cells for intensity transform analysis, each cell in the matrix of cells distributed as a function of a first dimension and second dimension, the first dimension being a unit of time;
analyzing the operational data; and
generating a plot having a first axis along the first dimension and a second axis along the second dimension.

3. The computer-implemented method of claim 2, wherein the collecting operational data from the facility further comprises storing the operational data in a database.

4. The computer-implemented method of claim 2, further comprising ascribing to each operational data a visual indicator based on one or more predetermined threshold operational data values, thereby generating visual indicators associated with the operational data.

5. The computer-implemented method of claim 4, wherein ascribing to each operational data a visual indicator comprises ascribing to each operational data a number that is a fraction or percentage of the one or more predetermined threshold operational data values.

6. The computer-implemented method of claim 4, wherein the visual indicator is selected from one or more colors, symbols, or pseudo-three dimensional objects.

7. The computer-implemented method of claim 4, further comprising normalizing the operational data before ascribing to each operational data a visual indicator.

8. The computer-implemented method of claim 4, wherein generating the plot comprises displaying the matrix of cells overlaid with the visual indicators

9. The computer-implemented method of claim 8, further comprising displaying a flagged visual indicator with a visual indicator ascribed to one or more operational data.

10. The computer-implemented method of claim 2, wherein analyzing the operational data includes comparing each operational data to a threshold value and flagging the operational data point if the operational data is above the threshold value.

11. The computer-implemented method of claim 2, wherein analyzing the operational data comprises performing one or more of modeling, fault analysis, consumption analysis, baseload analysis, off-hour analysis, real-time pricing and trend analysis, error analysis, and predictive modeling.

12. The computer-implemented method of claim 2, wherein the operational data is selected from energy consumption, valve position, cooling rate, heating rate and heat loss.

13. The computer-implemented method of claim 2, wherein the plot is a color-coded plot.

14. The computer-implemented method of claim 2, wherein the unit of time is selected from seconds, minutes, hours and days.

15. The computer-implemented method of claim 2, wherein the second dimension is a unit of time or location.

16. The computer-implemented method of claim 15, wherein the second dimension is a unit of time selected from days, weeks, months and years.

17. The computer-implemented method of claim 2, wherein the first dimension and the second dimension are each a non-cyclic timeframe.

18. The computer-implemented method of claim 2, further comprising correlating the operational data with one or more factors internal or external to the facility.

19. The computer-implemented method of claim 2, further comprising flagging one or more operational data based on one or more other predetermined threshold operational data values.

20. The computer-implemented method of claim 19, further comprising associating an alert . or notification or user generated comment with the flagged one or more operational data.

21. The computer-implemented method of claim 19, further comprising providing a flagged visual indicator to each flagged one or more operational data.

22. A system for displaying operational data for a facility, comprising:
an operational data collection module for collecting operational data from a gateway module communicatively coupled to a facility;
a cell module communicatively coupled to the operational data collection module, the cell module for providing operational data from the operational data collection module into a cell among a matrix of cells, each cell in the matrix of cells distributed as a function of a first dimension and second dimension; and
an analysis module, the analysis module for analyzing the operational data in the matrix of cells.

23. The system of claim 22, wherein the GUI permits a user to select a method for analyzing the operational data.

24. The system of claim 22, wherein the GUI permits a user to correlate the operational data with one or more other data.

25. The system of claim 22, wherein operational data includes energy consumption.

26. The system of claim 22, further comprising a graphical user interface (GUI) for displaying an intensity transform plot, the GUI for generating an operational data plot using operational data from the cell module, the operational data plot having a first axis along the first dimension and a second axis along the second dimension.
